(19) United States
(12) Patent Application Publication
(10) Pub. No.: US 2021/0073966 A1
(43) Pub. Date: Mar. 11, 2021

(54) IMAGE INSPECTION DEVICE, IMAGE FORMING DEVICE, IMAGE INSPECTION METHOD AND RECORDING MEDIUM

(71) Applicant: KONICA MINOLTA, INC., Tokyo (JP)

(72) Inventors: Katsunori TESHIMA, Tokyo (JP); Yasushi TSUE, Tokyo (JP)

(73) Assignee: KONICA MINOLTA, INC., Tokyo (JP)

(21) Appl. No.: 17/005,421

(22) Filed: Aug. 28, 2020

(30) Foreign Application Priority Data
Sep. 10, 2019 (JP) 2019-164445

(51) Int. Cl. G06T 7/00; G06T 7/13

(52) U.S. Cl. CPC G06T 7/001; G06T 7/13; G06T 2207/30168; G06T 2207/30144; G06T 2207/10008

(57) ABSTRACT

An image inspection device includes a capture unit and an image inspection unit. The capture unit captures a read image. The image inspection unit detects an image defect in an inspection image captured by the capture unit by comparing the inspection image with a reference image that consists of an RIP image, the inspection image being obtained by reading a sheet to be inspected on which an image corresponding to the reference image is formed. The image inspection unit performs color conversion from CMYK to RGB on the reference image, compares the inspection image in RGB with the reference image in RGB to check difference, and makes a threshold for detecting an image defect larger or does not detect an image defect, for a portion of the reference image where a change in a particular color is more than a predetermined value.

### BACKGROUND

### 1. Technological Field

The present invention relates to an image inspection device, an image forming device, an image inspection method and a recording medium.

### 2. Description of the Related Art

Color deviation or distortion occasionally occurs in a printed matter printed by an image forming device, resulting in defective products. In view of this, known image inspection devices detect defects (image defect) on a printed matter based on, for example, difference between a reference image and a read image. The reference image is generated by performing a color conversion process on an original image from which the printed matter is generated. The read image (inspection image) is generated by electrically reading the printed matter (with a scanner). The device checks quality of the printed matter based on the detected image defect.

In one example, an original document and a printed document are read by a scanner, and a streak in the read image is detected using a mask effect visual model (see JP 2017-32572A for example).

In another example, differences are compared between an image of a print controller (reference image) and a scanned image obtained by reading a document (read image). A threshold for difference is made smaller for charts where errors tend to occur (see JP 2015-179073A for example).

In still another example, a scanner reads a reference chart. A color conversion table is prepared and an image defect in a document is detected. In detection, a threshold for detection is made larger for a region not included in the color conversion table (see JP 2018-44896A for example).

However, the above configuration of JP 2017-32572A has a problem that the RIP image from the print controller cannot be inspected. According to above JP 2015-179073A, when color conversion from CMYK to RGB is performed on an image of the print controller, mixture of CMYK colors is not taken into account. This brings a problem of erroneous detection, depending on accuracy in color conversion, in a case in which a certain color changes. According to the above JP 2018-44896A, in all of the regions not included in the color conversion table, a threshold for detecting an image defect is made larger. It brings a problem of reduced accuracy in detecting an image defect.

### SUMMARY

It is an object of the present invention to provide an image inspection device, an image forming device, an image inspection method and a recording medium that improves accuracy in detecting an image defect in a printed matter.

To achieve at least one of the abovementioned objects, according to an aspect of the present invention, an image inspection device includes:

a capture unit that captures a read image from an image reading device that optically reads a sheet output from an image forming device that forms an image on a sheet; and

an image inspection unit that detects an image defect in an inspection image captured by the capture unit by comparing the inspection image with a reference image that consists of an RIP image from a print controller, the inspection image being obtained by reading, with the image reading device, a sheet to be inspected on which an image corresponding to the reference image is formed,

wherein the image inspection unit

performs color conversion from CMYK to RGB on the reference image,

compares the inspection image in RGB with the reference image in RGB to check difference, and

makes a threshold for detecting an image defect larger or does not detect an image defect, for a portion of the reference image where a change in a particular color is equal to or more than a predetermined value.

According to another aspect of the present invention, an image inspection method for an image inspection device includes:

capturing a read image from an image reading device that optically reads a sheet output from an image forming device that forms an image on a sheet; and

detecting an image defect in an inspection image captured in the capturing by comparing the inspection image with a reference image that consists of an RIP image from a print controller, the inspection image being obtained by reading, with the image reading device, a sheet to be inspected on which an image corresponding to the reference image is formed,

wherein the detecting comprises:

performing color conversion from CMYK to RGB on the reference image;

comparing the inspection image in RGB with the reference image in RGB to check difference; and

making a threshold for detecting an image defect larger or not detecting an image defect, for a portion of the reference image where a change in a particular color is equal to or more than a predetermined value.

According to still another aspect of the present invention, a non-transitory computer readable medium stores a program that makes a computer to function as:

a capture unit that captures a read image from an image reading device that optically reads a sheet output from an image forming device that forms an image on a sheet; and

an image inspection unit that detects an image defect in an inspection image captured by the capture unit by comparing the inspection image with a reference image that consists of an RIP image from a print controller, the inspection image being obtained by reading, with the image reading device, a sheet to be inspected on which an image corresponding to the reference image is formed,

wherein the image inspection unit

performs color conversion from CMYK to RGB on the reference image,

compares the inspection image in RGB with the reference image in RGB to check difference, and

makes a threshold for detecting an image defect larger or does not detect an image defect, for a portion of the reference image where a change in a particular color is equal to or more than a predetermined value.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram showing a functional configuration of an image forming system according to an embodiment.

FIG. 2 is a front view showing schematic configurations of an image forming device and an image inspection device.

FIG. 3 is a flowchart showing an example of operation of the image forming system (the image inspection device) according to the embodiment.

FIG. 4 shows an example of comparison between Rch obtained by scanning with an image reading device and Rch obtained by performing RGB conversion on RIP data.

FIG. 5 shows an example of a graph obtained by plotting a three-pixel difference of each Rch in FIG. 4.

FIG. 6 is a block diagram showing a functional configuration of an image forming system according to Modification 1.

FIG. 7 is a block diagram showing a functional configuration of an image forming system according to Modification 2.

FIG. 8 is a block diagram showing a functional configuration of an image forming system according to Modification 3.

FIG. 9 shows an example of an RGB conversion table prepared for each grid point in CMYK.

### DETAILED DESCRIPTION OF EMBODIMENTS

Hereinafter, one or more embodiments of the present invention will be described with reference to the drawings. However, the scope of the invention is not limited to the disclosed embodiments.

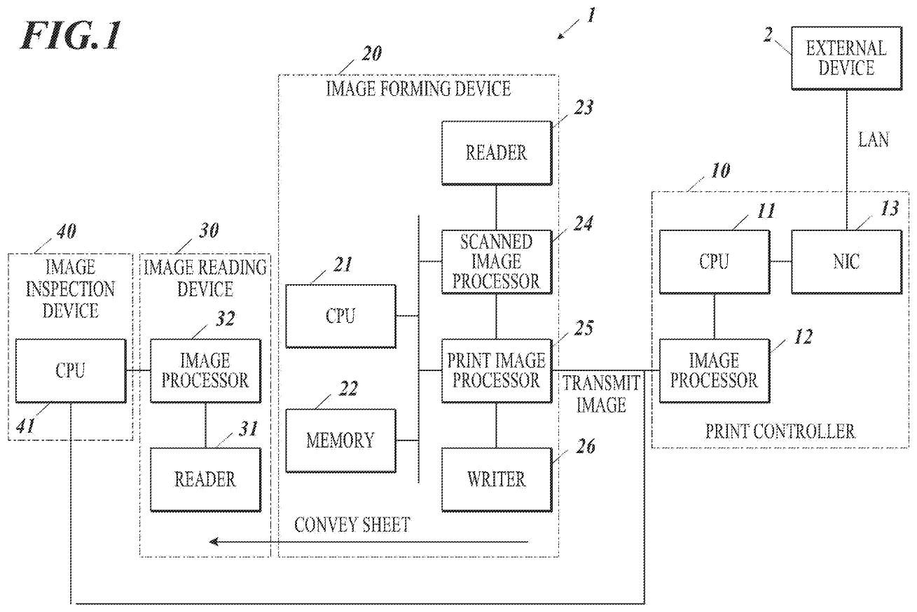

An image forming system 1 according to the embodiment is an all-in-one printer. The image forming system 1 forms an image of image data read from a document on a sheet (recording medium), and outputs it. The image forming system 1 also forms an image on a sheet based on image data received from an external device 2 (see FIG. 1) such as a PC via a LAN, and outputs it.

As shown in FIG. 1, the image forming system 1 includes a print controller 10, an image forming device 20, an image reading device 30, and an image inspection device 40. The image forming system 1 is connected to the external device 2 via an NIC 13 of the print controller 10 to transmit and receive data to and from the external device 2.

In a case in which the image forming device 20 is used as a network printer, the print controller 10 manages and controls image data input to the image forming device 20 from the external device 2 connected to the LAN. The print controller 10 receives image data to be printed from the external device 2 and transmits it to the image forming device 20.

The print controller 10 includes a CPU 11, an image processor 12, and the NIC 13.

The CPU 11 comprehensively controls operation of units of the print controller 10 and outputs image data input from the external device 2 to the image forming device 20 via the NIC 13.

The image processor 12 performs rasterization (RIP) processing on the image data input from the external device 2 and generates image data (RIP image data: reference image) in each CMYK color.

The NIC (network interface card) 13 is a communication interface that receives image data to be printed from the external device 2 via the LAN.

The image forming device 20 includes a CPU 21, a memory 22, a reader 23, a scanned image processor 24, a print image processor 25, and a writer 26.

The CPU 21 reads various programs from the memory 22, expands the programs in a RAM, and executes the programs to control units of the image forming device 20.

The memory 22 stores programs readable by the CPU 21, files for executing programs, and the like. The memory 22 may be a mass memory, such as a hard disk.

The reader 23 includes an auto document conveyance device and a scanner. The reader 23 reads the surface of a document placed on a document table to generate bitmap image data. Each pixel of the image data generated by the reader 23 has three color pixel values of R (red), G (green), and B (blue). The image data is converted into image data having pixel values of four colors C, M, Y, and K.

The scanned image processor 24 performs various processing, such as analog processing, A/D conversion processing, and shading processing, on analog image data input from the reader 23, and then generates digital image data. The generated image data is output to the print image processor 25.

The print image processor 25 generates print image data for image formation based on image data input from the scanned image processor 24 or from the image processor 12 of the print controller 10, and outputs the print image data to the writer 26.

The writer 26 performs an image formation processing in an electrophotographic method. The writer 26 forms an image in four colors of C, M, Y, and K on a sheet in accordance with pixel values of the four colors of pixels in image data processed by the print image processor 25.

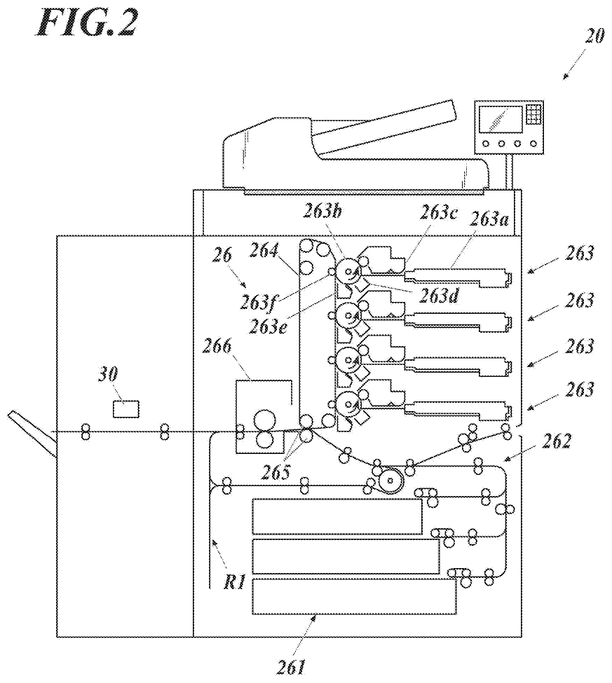

As shown in FIG. 1 and FIG. 2, the writer 26 includes a paper feeder 261, a conveyor 262, four writing units 263, an intermediate transfer belt 264, a transfer unit 265, and a fixer 266. The writer 26 of the embodiment is an example in which an electrophotographic method is applied. However, the printing method is not limited to this. Other printing methods, such as an ink jet method and a thermal sublimation method, may be applied.

The paper feeder 261 has a paper feed mechanism that includes paper feed trays each including paper feed rollers, separation rollers, a paper feed/separation rubber, and sending rollers. Each paper feed tray stores sheets, the type of the sheets (paper type, basis weight, sheet size, and the like) being distinguished in advance. The paper feed mechanism conveys the top sheet one by one to conveyor 262.

The conveyor 262 conveys the sheet conveyed from the paper feeder 261 to a sheet conveyance path toward the transfer unit 265 via intermediate rollers, resist rollers, and the like. The conveyor 262 then conveys the sheet to a secondary transfer position of the writer 26.

The four writing units 263 are arranged in series (tandem) along the belt plane of the intermediate transfer belt 264 to form images in C, M, Y and K colors. The writing units 263 have the same configuration except that they form images in different colors. As shown in FIG. 2, each of the writing units 263 includes an exposer 263a, a photosensitive drum 263b, a development unit 263c, a charger 263d, a cleaner 263e, and a primary transfer roller 263f.

To form images, the charger 263d of each writing unit 263 charges the photosensitive drum 263b. Thereafter, the photosensitive drum 263b is scanned with luminous flux emitted by the exposer 263a based on image data. Thus, an electrostatic latent image is formed. The development unit 263c then supplies a toner for development, and an image is formed on the photosensitive drum 263b.

The primary transfer rollers 263f of the four writing units 263 then sequentially transfer images formed on the photosensitive drums 263b to the intermediate transfer belt 264 so that the images overlap (primary transfer). Thus, an image in colors are formed on the intermediate transfer belt 264. After the primary transfer, the cleaner 263e removes a toner remaining on the photosensitive drum 263b.

The paper feeder 261 of the writer 26 sends a sheet, and the transfer unit 265 transfers an image from the intermediate transfer belt 264 to the sheet (secondary transfer). Thereafter, the fixer 266 applies heat and pressure on the sheet to perform fixation.

In a case in which images are to be formed on both sides of a sheet, the sheet is conveyed to a conveyance path R1, turned upside down, and then conveyed to the transfer unit 265 again.

The image reading device (ICCU) 30 includes a reader 31 and an image processor 32.

The reader 31 includes, for example, a linear image sensor (e.g., CCD line sensor), an optical system, and a light source. The reader 31 reads a sheet to which a toner image is transferred and outputs the read image to the image processor 32.

The image processor 32 performs various processing, such as analog processing, A/D conversion processing, and shading processing, on analog image data input from the reader 31. The image processor 32 then generates digital image data in RGB. The generated image data is output to a CPU 41 of the image inspection device 40.

The image inspection device 40 includes the CPU 41. The image reading device 30 reads a sheet on which an image is formed (transferred) by the image forming device 20. The image inspection device 40 inspects (detects) the read image for an image defect (streak).

The CPU 41 comprehensively controls operation of units in the image inspection device 40. For example, the CPU 41 functions as a capture unit of the present invention which captures a read image from an image reading device 30 that optically reads a sheet output from an image forming device 20. The CPU 41 also functions as an image inspection unit of the present invention which detects an image defect in an inspection image captured by the capture unit by comparing the inspection image with a reference image that consists of an RIP image from a print controller 10, the inspection image being obtained by reading, with the image reading device 30, a sheet to be inspected on which an image corresponding to the reference image is formed.

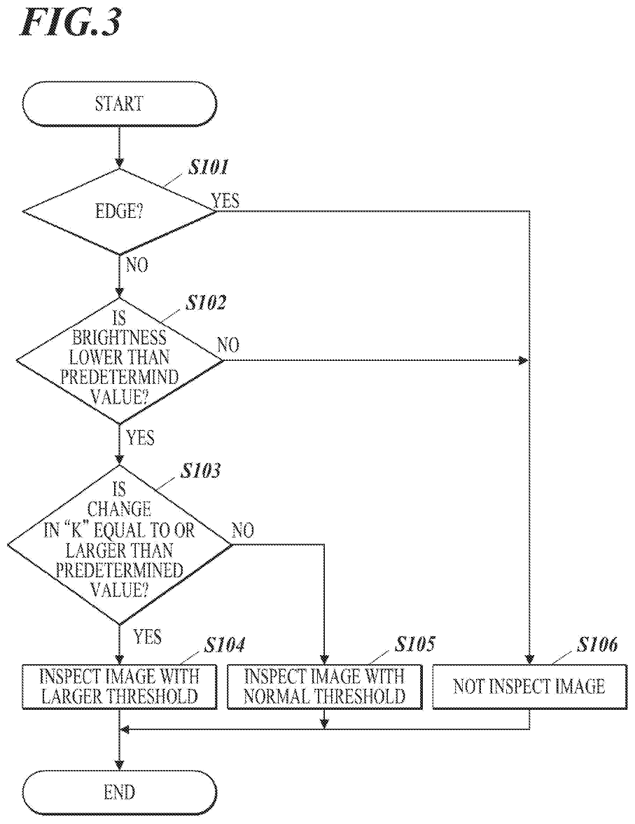

Next, operation of the image forming system 1 (image inspection device 40) according to the embodiment will be explained with reference to a flowchart in FIG. 3.

First, the CPU 41 of the image inspection device 40 determines whether a portion to be inspected (portion for comparison) is an edge portion (Step S101). Specifically, the CPU 41 extracts edges in each image using an edge extraction filter or the like before comparison between the reference image and the inspection image, and determines whether the portion to be inspected is an edge portion.

If the CPU 41 determines that the portion to be inspected is an edge portion (Step S101: YES), the process proceeds to Step S106, and the CPU 41 ends the process without performing image inspection (streak inspection).

On the other hand, if the CPU 41 determines that the portion to be inspected is not an edge portion (in other words, it is a portion without an edge) (Step S101: NO), the process proceeds to the following Step S102.

Next, the CPU 41 determines whether the brightness of the portion to be inspected is lower than a predetermined value (Step S102).

If the CPU 41 determines that the brightness of the portion to be inspected is lower than the predetermined value (Step S102: YES), the process proceeds to the following Step S103.

On the other hand, if the CPU 41 determines that the brightness of the portion to be inspected is not lower than the predetermined value (in other words, equal to or more than the predetermined value) (Step S102: NO), the process proceeds to Step S106. Thus the CPU 41 ends the process without performing image inspection (streak inspection). Instead of proceeding to Step S106, the CPU 41 may proceed to Step S105 to inspect the image with a normal threshold.

The reason why whether the brightness of the portion to be inspected is lower than the predetermined value is determined in Step S102 is that, in a case in which the brightness is lower (darker) than the predetermined value, change in brightness may be reversed at a point where K changes in an RIP data in mixed CMYK colors when RGB conversion is performed.

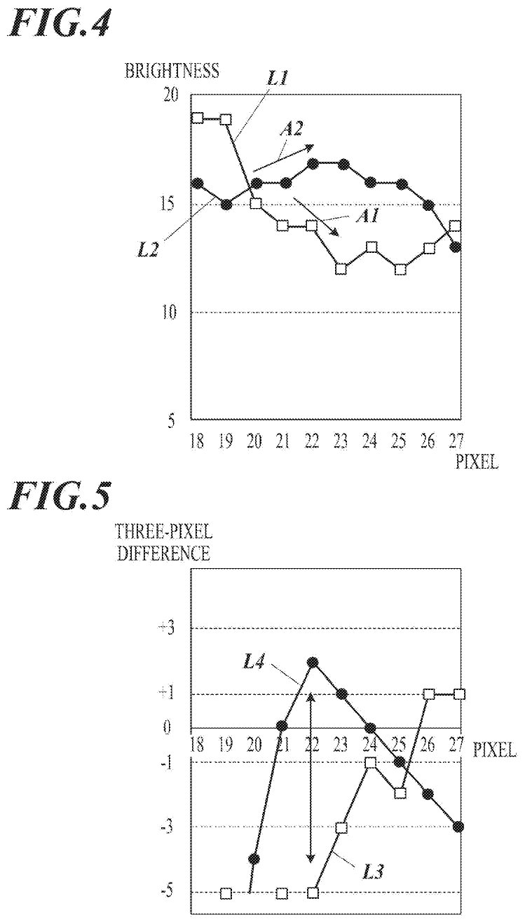

FIG. 4 shows an example of a comparison between Rch scanned by the image reading device 30 and Rch obtained by performing RGB conversion on an RIP data. As shown by arrows A1 and A2 in the example of FIG. 4, change in brightness is reversed between the graph L1 of the Rch of the scan data and the graph L2 of the Rch of the RIP data after color conversion.

Next, the CPU 41 determines whether a change in a particular color (K) is equal to or more than a predetermined value in a predetermined region of the reference image (Step S103). The reason why whether the change in the particular color in the predetermined region is equal to or more than the predetermined value is determined is that, in a portion where the change in the particular color is equal to or more than the predetermined value, change in brightness may be reversed when RGB conversion is performed. The CPU 41 determines in advance a color which is likely to cause an error as the particular color (K in the embodiment) with an analysis algorithm.

If the CPU 41 determines that the change in K in the predetermined region is equal to or more than the predetermined value (Step S103: YES), the process proceeds to the next Step S104 to inspect the image with a larger (higher) threshold (for detecting an image defect).

On the other hand, if the CPU 41 determines that the change in K in the predetermined region is not equal to or more than the predetermined value (in other words, the change in K is less than the predetermined value) (Step S103: NO), the process proceeds to Step S105 to inspect the image with the normal threshold.

To inspect an image in Step S104 to Step S106, the CPU 41 performs color conversion from CMYK to RGB on the reference image. The CPU 41 then compares the RGB inspection image (a portion without an edge) with the RGB reference image (the portion without an edge) to check difference. The CPU 41 extracts three-pixel difference in brightness (difference between a first pixel and a second pixel that precedes the first pixel by three pixels) in each of the reference image and the inspection image. If the difference in the three-pixel difference is equal to or more than a threshold, the CPU 41 assumes that there is a streak (the CPU detects an image defect).

In a case in which the three-pixel difference is extracted while change in brightness is reversed as shown in FIG. 4, the difference between the graph L3 and the graph L4 in a portion where change in brightness is reversed is larger as shown in FIG. 5, L3 being a graph of the three-pixel difference of the Rch of the scan data, and L4 being a graph of the three-pixel difference of the Rch of the RIP data after color conversion. Therefore, even if no streak is generated, a streak may be erroneously detected. Therefore, in Step S103, if the CPU 41 determines that the change in K in the predetermined region is equal to or more than the predetermined value (i.e., there is a possibility that change in brightness is reversed), the CPU 41 makes the threshold for detecting an image defect larger (see Step S104). Thus erroneous detection of a streak is prevented.

In Step S104, if the change in K in the predetermined region is determined to be equal to or more than the predetermined value, the threshold for detecting an image defect is made larger. However, the present invention is not limited thereto. For example, instead of making the threshold for detecting an image defect larger, detection of an image defect may not be performed.

As described above, the image inspection device 40 of the image forming system 1 according to the embodiment includes:

the capture unit (CPU 41) that captures a read image from the image reading device 30 that optically reads a sheet output from the image forming device 20 that forms an image on a sheet; and

the image inspection unit (CPU 41) that detects an image defect in an inspection image captured by the capture unit by comparing the inspection image with a reference image that consists of an RIP image from the print controller 10, the inspection image being obtained by reading, with the image reading device 30, a sheet to be inspected on which an image corresponding to the reference image is formed.

The image inspection unit performs color conversion from CMYK to RGB on the reference image. The image inspection unit then compares the inspection image in RGB with the reference image in RGB to check difference. The image inspection unit makes a threshold for detecting an image defect larger or does not detect an image defect for a portion of the reference image where a change in a particular color is equal to or more than a predetermined value.

Therefore, the image inspection device 40 according to the embodiment suppresses erroneous detection of a streak caused by change in brightness at the time of color conversion. This improves accuracy in detection of an image defect in a printed matter.

According to the image inspection device 40 of the embodiment, the image inspection unit extracts edges before comparing the inspection image with the reference image. The image inspection unit checks difference in a portion without an edge.

Therefore, according to the image inspection device 40 of the embodiment, an image is inspected in a portion without an edge, where an image defect can be detected. It improves accuracy in detection of an image defect.

According to the image inspection device 40 of the embodiment, the image inspection unit extracts three-pixel difference to compare the inspection image with the reference image. The image inspection unit detects an image defect when difference in the three-pixel difference between the inspection image and the reference image is equal to or more than a threshold.

Thus, the image inspection device 40 of the embodiment easily inspect an image and easily detect an image defect in the inspection image.

According to the image inspection device 40 of the embodiment, the image inspection unit determines in advance a color which is likely to cause an error as a particular color with an analysis algorithm.

Therefore, the image inspection device 40 according to the embodiment predicts erroneous detection of a streak caused by change in brightness at the time of color conversion. It improves accuracy in detection of an image defect.

While the present invention has been specifically described with reference to the embodiment according to the present invention, the invention is not limited to the embodiment and can be modified within the scope of the claims.

Modification 1

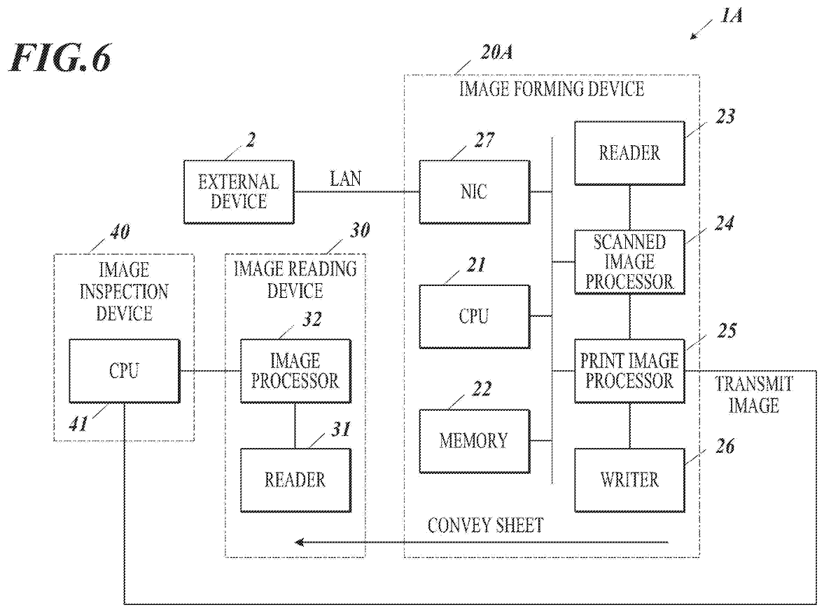

In the explanation of the embodiment, the image forming system 1 including the print controller 10, the image forming device 20, the image reading device 30, and the image inspection device 40 is exemplified. However, the present invention is not limited thereto. For example, as shown in FIG. 6, the CPU 21 of the image forming device 20 may have a function of a CPU 11 of the print controller 10 so that the image forming device 20 and the print controller 10 are integrated.

That is, the image forming system 1A in Modification 1 consists of the image forming device 20A, the image reading device 30, and the image inspection device 40. The image forming device 20A includes the CPU 21, the memory 22, the reader 23, the scanned image processor 24, the print image processor 25, the writer 26, and an NIC 27.

The CPU 21 of the image forming device 20A has a function of outputting an image data input from the external device 2 via the NIC 27 to the print image processor 25 in addition to the function in the above embodiment.

Modification 2

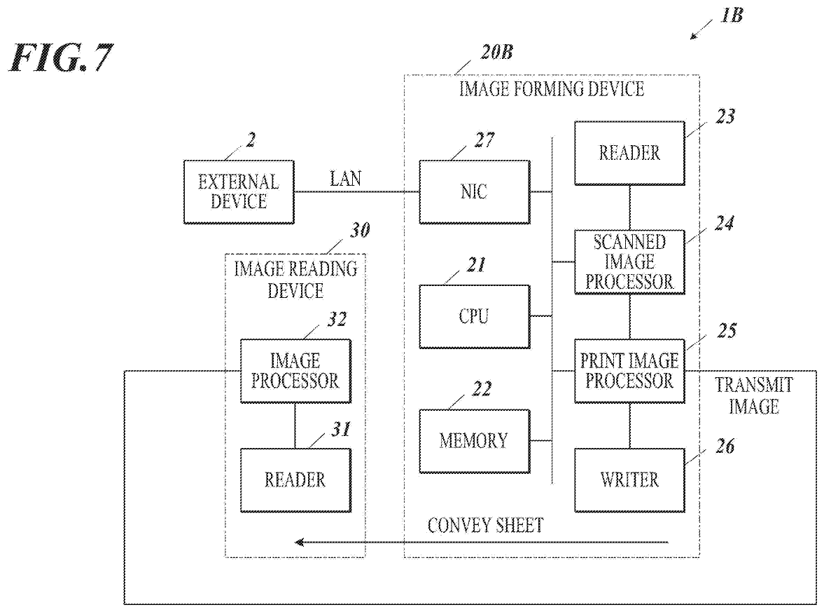

As illustrated in FIG. 7, the CPU 21 of the image forming device 20 may have functions of the CPU 11 of the print controller 10 and the CPU 41 of the image inspection device 40 so that the image forming device 20, the print controller 10, and the image inspection device 40 are integrated.

That is, the image forming system 1B according to Modification 2 consists of an image forming device 20B and the image reading device 30.

The CPU 21 of the image forming device 20B has functions of the capture unit and the image inspection unit of the present invention in addition to the functions in Modification 1. That is, the CPU 21 of the image forming device 20B also functions as an image inspection device of the present invention.

Modification 3

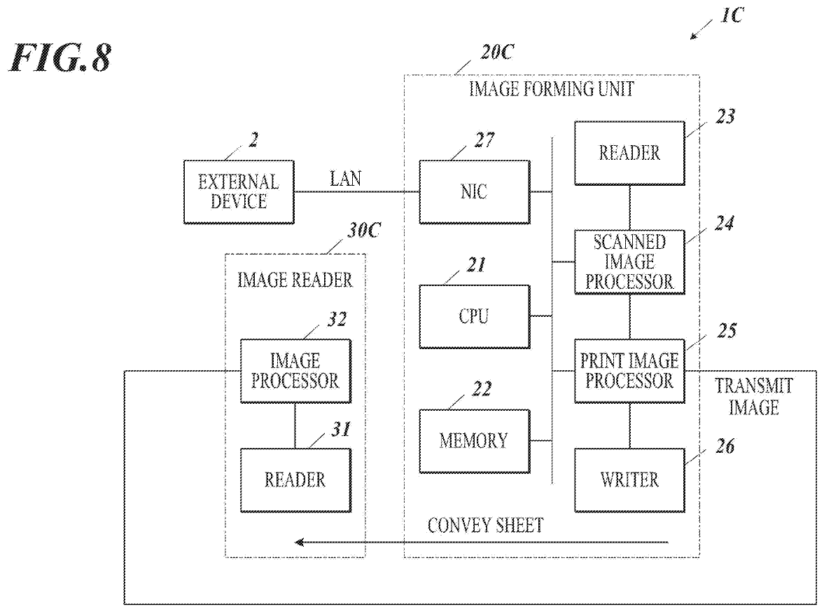

As shown in FIG. 8, the CPU 21 of the image forming device 20 may have a function of controlling the image reading device 30 in addition to the functions of the CPU 11 of the print controller 10 and the CPU 41 of the image inspection device 40. Thus, in Modification 3, all the devices (functions) that constitute the image forming system 1 are brought together as the single image forming device 20.

That is, the image forming device 1C according to Modification 3 consists of an image forming unit 20C and an image reader 30C.

Like Modification 2, the CPU 21 of the image forming unit 20C functions as the capture unit and the image inspection unit of the present invention. That is, the CPU 21 of the image forming unit 20C also functions as the image inspection device of the present invention. The CPU 21 of the image forming unit 20C has a function to control the image reader 30C in addition to the functions in Modification 2.

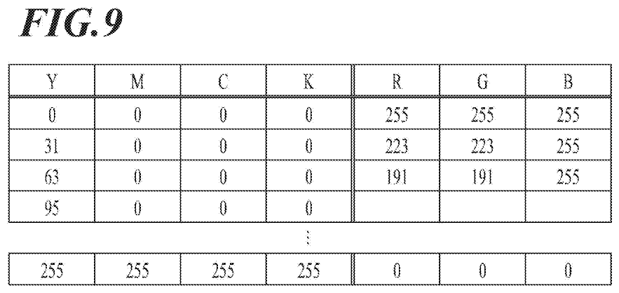

As a method of performing color conversion from CMYK to RGB on the reference image (RIP data), Grid points in CMYK may be provided. A conversion table in relation with RGB is prepared for each grid point (see FIG. 9). In this case, color conversion to RGB is performed on pixels at the grid points while referring to the conversion table. For pixels not at grid points, the RGB value is obtained by interpolation between neighboring grid points.

In the embodiment, K is exemplified as a particular color that is likely to cause an error. However, the present invention is not limited thereto. For example, either Y, M, or C may be determined as the particular color instead of K.

Detailed configuration and operation of devices constituting the image forming system may be modified within scope of the claims of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2019-164445, filed on Sep. 10, 2019, is incorporated herein by reference in its entirety.

What is claimed is:

1. An image inspection device comprising:
a capture unit that captures a read image from an image reading device that optically reads a sheet output from an image forming device that forms an image on a sheet; and
an image inspection unit that detects an image defect in an inspection image captured by the capture unit by comparing the inspection image with a reference image that consists of an RIP image from a print controller, the inspection image being obtained by reading, with the image reading device, a sheet to be inspected on which an image corresponding to the reference image is formed,
wherein the image inspection unit
performs color conversion from CMYK to RGB on the reference image,
compares the inspection image in RGB with the reference image in RGB to check difference, and
makes a threshold for detecting an image defect larger or does not detect an image defect, for a portion of the reference image where a change in a particular color is equal to or more than a predetermined value.

2. The image inspection device according to claim 1, wherein
the image inspection unit extracts edges before comparing the inspection image with the reference image, and
the image inspection unit checks for difference in a portion without an edge.

3. The image inspection device according to claim 1, wherein
the image inspection unit extracts three-pixel difference to compare the inspection image with the reference image, and
the image inspection unit detects an image defect when difference in the three-pixel difference between the inspection image and the reference image is equal to or more than the threshold.

4. The image inspection device according to claim 1, wherein the image inspection unit determines in advance a color which is likely to cause an error as the particular color with an analysis algorithm.

5. An image forming device comprising:
an image forming unit that forms an image on a sheet;
an image reader that optically reads a sheet output from the image forming unit; and
the image inspection device according to claim 1.

6. An image inspection method for an image inspection device, comprising:
capturing a read image from an image reading device that optically reads a sheet output from an image forming device that forms an image on a sheet; and
detecting an image defect in an inspection image captured in the capturing by comparing the inspection image with a reference image that consists of an RIP image from a print controller, the inspection image being obtained by reading, with the image reading device, a sheet to be inspected on which an image corresponding to the reference image is formed,
wherein the detecting comprises:
performing color conversion from CMYK to RGB on the reference image;
comparing the inspection image in RGB with the reference image in RGB to check difference; and
making a threshold for detecting an image defect larger or not detecting an image defect, for a portion of the reference image where a change in a particular color is equal to or more than a predetermined value.

7. A non-transitory computer readable medium storing a program that makes a computer to function as:
a capture unit that captures a read image from an image reading device that optically reads a sheet output from an image forming device that forms an image on a sheet; and
an image inspection unit that detects an image defect in an inspection image captured by the capture unit by comparing the inspection image with a reference image that consists of an RIP image from a print controller, the inspection image being obtained by reading, with the image reading device, a sheet to be inspected on which an image corresponding to the reference image is formed,
wherein the image inspection unit
performs color conversion from CMYK to RGB on the reference image,
compares the inspection image in RGB with the reference image in RGB to check difference, and
makes a threshold for detecting an image defect larger or does not detect an image defect, for a portion of the reference image where a change in a particular color is equal to or more than a predetermined value.
